(19) United States
(12) Patent Application Publication
(10) Pub. No.: US 2016/0290718 A1
(43) Pub. Date: Oct. 6, 2016

(54) METHOD OF AND DEVICE FOR DYE SUBLIMATION

(71) Applicant: Imagekiwi Inc., Fremont, CA (US)

(72) Inventors: Yanqiang Ye, Fremont, CA (US); Chih-Cheng Tai, Campbell, CA (US)

(21) Appl. No.: 15/085,916

(22) Filed: Mar. 30, 2016

Related U.S. Application Data
(60) Provisional application No. 62/142,860, filed on Apr. 3, 2015.
(60) Provisional application No. 62/191,909, filed on Jul. 13, 2015.

(51) Int. Cl. F27B 9/04; H05B 3/66; H05B 3/00

(52) U.S. Cl. CPC F27B 9/042; H05B 3/0014; H05B 3/66

(57) ABSTRACT

A vacuum dye sublimation or dye transferring machine provides an even heating mechanism and structures for avoiding a position shifting of a dye sublimation film. A color changing coating composition comprises a first amount of polyurethane, a second amount of curing compounds/agents or hardening agent, a third amount of thermalchromic pigment, and a fourth amount of a solvent. A wall decoration method and device.

### CROSS-REFERENCE TO RELATED APPLICATION(S)

The present invention claims priority to the U.S. provisional patent application Ser. No. 62/142,860, titled “VACUUM DYE SUBLIMATION DEVICE AND THE METHOD OF USING THE SAME,” filed on Apr. 3, 2015 and U.S. provisional patent application Ser. No. 62/191,909, titled “COLOR CHANGING SURFACES USING A DYE SUBLIMATION PROCESS,” filed on July 13, which are both incorporated by reference in their entireties for all purposes.

### FIELD OF INVENTION

The present invention relates to dye sublimation. Specifically, the present invention relates to methods of and devices for dye sublimation and the applications thereof.

### BACKGROUND OF THE INVENTION

FIG. 1 illustrates a conventional vacuum tray 100. An opening angle 110 is formed when the loading tray 106 couples with the cover 108, which causes uneven heating on an object 116 having a zone 112 under a higher temperature than the zone 114. The brief uneven heating causing a deformation of the object 116, such as a polyethylene (PE) film, resulting in an inferior or damaged product.

In another aspect, typically photos on the wall are hung by using nails and wires. The photos are typically printed on photo paper and framed by a wood or plastic frame. The colors of the photo fade away and the paper can become yellow over time. The nails on the wall cause nail holes, which are permanent damages to the wall.

### SUMMARY OF THE INVENTION

Method of and Device for Dye Sublimation with a Vacuum

In an aspect, a method of dye sublimation comprises loading an object for image printing/sublimating to a loading tray, loading a sublimation film with an predetermined image printed with a sublimation dye on the loading tray, immobilizing the sublimation film by using a frame, immobilizing subdivisions of the film by using a reinforced structure, and transferring the image to the object by applying a predetermined temperature for sublimation.

Color Changing Surfaces Using a Dye Sublimation Process

In an aspect, a method of making color changing surfaces uses a dye sublimation process. The color change can be trigger by temperature, moisture, or various lights or radiations (such as UV, IR, or no lights (e.g., a dark environment).

In some embodiments, the dry sublimation process comprises preparing a coating composition in a solution, spraying or curtain coating the solution on a surface of an applying object forming a layer of coating, and baking the object at a temperature (e.g., 80° C.) for a predetermined duration (e.g., 50 minutes). In some embodiments, UV curing light is used to cure the coating.

In some embodiments, the coating composition comprises a first amount of polyurethane, a second amount of curing compounds/agents or hardening agent (e.g., MOCA [4,4′-Methylene bis-(ortho-chloroaniline)]), a third amount of thermalchromic pigment (e.g., [(CH₃CH₂)NH₂]CuCl₄) and a fourth amount of a solvent (e.g., dimethylbenzene/xylol and butanone). In some embodiments, the ratio by weight of the first amount, the second amount, the third amount, and the fourth amount is 3:1:0.25:1. In some embodiments, the ratio by mole number of the first amount, the second amount, the third amount, and the fourth amount is 3:1:0.25:1.

In some embodiments, the thermalchromic pigment can be selected with a triggering condition, such as selecting a pigment that changes its color at a predetermined temperature, for example, human body temperature 38° C., room temperature 25° C., ice freezing point 0° C., or any other predetermined temperature. In some embodiments, a chromic pigment added is selected to be UV sensitive, such that the color changing condition can be a predetermined strength of a light, for example, UV index 10 or a sun safe UV index. In some embodiments, the chromic pigment is selected to be a moisture sensitive compound or a mixture (e.g. CaCl₂ contained), such that the color changing condition can be a degree of moisture in the air.

In some embodiments, the polyurethane is replaced by or used along one or more epoxide based and/or epoxy resin compounds. In some embodiments, the hardness, brightness, and adhesiveness can be enhanced or strengthened by adding one or more nanoparticles (e.g. nanoparticles of silicon oxide (SiO₂), aluminium oxide (Al₂O₃), and/or chromium (III) oxide (CrO2)). In some embodiments, the nanoparticles are in the composition from 0.3%-10% by weight. In some embodiments, the nanoparticles have an average size equal or less than 200 nm. In some other embodiments, the nanoparticles have an average size equal or less than 15 nm.

In some embodiments, the composition further comprises UV resistant agent. The UV resistant agent can be UV resistant resin (e.g., Rynite® 935SUV, which is a 35% glass-fiber/mineral reinforced, UV stabilized grade of polyethylene terephtalate (PET); and Rynite® 540SUV, which is a 40% glass-fiber reinforced, UV stabilized grade of PET). Any other compounds that can be chemical resistant, high-abrasive material, anti-friction material, abrasion resistance, resistance to wear, and resistant to wear and tear are within the scope of the present invention.

Immobilizing Images or Pictures on the Wall or Building Structures

Methods of and devices for immobilizing images or pictures on the wall are disclosed. In some embodiments, a dye sublimated image piece (e.g., an image tile) is immobilized on a structure (e.g., a wall) through magnetic force and/or one of more adhesive substance, such as glue. In some embodiments, the adhesive substance comprises a pressure sensitive adhesive (PSA). In other embodiments, the adhesive substance comprises an amount/a type of glue that allows the image piece to be attached to and/or remove from an attaching surface (e.g., a painted wall, wall paper, a dry wall) without damaging the surface. In an example, the glue comprises a composition of a glue that is used on the 3M® POST IT. In some embodiments, Velcro® coins are used to attach the image piece to a wall. In some embodiments, the magnetic force is between the image piece and a wall. In some embodiments, the image piece comprises one or more magnets and the wall comprises a substance that can has a magnetic force attracting to the magnets on the image piece, such as an iron sheet or another magnet. Any substances that generate or attract to magnetic forces are within the scope of the present invention. For example, the wall comprises a magnet and the image piece comprises a metal sheet or a magnet. Ferrous metals or any substances that generate a magnetic force or attract a magnetic substance are within the scope of the present invention.

In some embodiments, a dye sublimation manufacturing process is used, which provides advantages features including printing/sublimating a high-resolution image to be fixed on a substrate. In some embodiments, the high-resolution image comprises an image transferred to a substrate having an image resolution in 600 dpi or higher, such as from 600 dpi to 4000 dpi. In some embodiments, the present invention performs a sublimation forming an image having an image resolution lower than 600 dpi, such as 300 dpi. In some embodiments, the present invention is able to form an image having a resolution from 10 dpi up to a resolution limitation of a printer (such as a digital printer).

In some embodiments, the substrate for sublimation comprises a polymer coating. In some embodiments, the polymer coating comprises a polyurethane based composition.

In an aspect, a sublimation system comprises a heating unit, a transporting unit having a vacuum element, a control unit controls the heating unit, the transporting unit, or both. In some embodiments, the transporting unit comprises a conveyer belt. In other embodiments, the vacuum element comprises a tube revolving along the transporting unit. In some other embodiments, the heating unit is configured to heat to a temperature for sublimation to occur at a press down motion. In some embodiments, the vacuum element is on each of the loading trays.

In another aspect, a sublimation system comprises a first section with a first heating element and a first transporting element and a second section with a second heating element and a second transporting element, wherein the first section is able to be connected with the second section forming an extended sublimation system. In some embodiments, the first transporting element comprises a structure for joining the second transporting element forming an extended transporting unit. In other embodiments, the extended transporting unit comprises a conveyer belt.

In another aspect, a sublimation system comprises a loading tray having a subdividing frame. In some embodiments, the subdividing frame is configured to immobile a sublimation sheet. In some embodiments, the sublimation sheet comprises at least two separated images printed using a sublimation dye. In other embodiments, the loading tray comprises a vacuum hole. In some other embodiments, the subdividing frame comprises at least three cavities. In some other embodiments, the subdividing frame comprises at least four cavities. In some embodiments, the system further comprises a bottom tray having positioning post locking a position of the subdividing frame. In some other embodiments, the bottom tray comprises a vacuum hole.

In another aspect, a sublimation system comprises a heating tunnel, a conveyer belt, and a loading tray having a vacuum element. In some embodiments, the loading tray comprises a upper section having one or more sublimation jig and a lower section containing a vacuum device. In other embodiments, the vacuum device comprises a pump. In some embodiments, the heating tunnel comprises a power supply extending along the heating tunnel. In other embodiments, the loading tray has a vacuum device is powered by the power supply. In some other embodiments, the loading tray comprises an I-sharp structure on a side.

### BRIEF DESCRIPTION OF THE DRAWINGS

FIG. 1 illustrates a conventional vacuum dye sublimation machine.

FIG. 2 illustrates a dye sublimation/transfer device in accordance with some embodiments of the present invention.

FIG. 3A illustrates a bottom view of the heating unit in accordance with some embodiments of the present invention.

FIG. 3B illustrates a loading tray in accordance with some embodiments of the present invention.

FIG. 3C illustrates an extendable enclosure in accordance with some embodiments of the present invention.

FIG. 4 illustrates a loading tray in accordance with some embodiments of the present invention.

FIG. 5A illustrates a working station in accordance with some embodiments of the present invention.

FIG. 5B illustrates a modularized working station in accordance with some embodiments of the present invention.

FIG. 6 illustrates another working station in accordance with some embodiments of the present invention.

FIG. 7 illustrates a loading tray in accordance with some embodiments of the present invention.

FIG. 8 illustrated an assembled loading tray to be placed into an oven for a dye sublimation process.

FIG. 9 is a flow chart illustrating a dye sublimation method in accordance with some embodiments of the present invention.

FIG. 10 illustrates a dye sublimation device 1000 in accordance with some embodiments of the present invention.

FIG. 11 illustrates a loading tray 1002 internal construction in accordance with some embodiments of the present invention.

FIG. 12 illustrates the heating tunnel 510 in accordance with some embodiments of the present invention.

FIGS. 13A-13D illustrates a working station in accordance with some embodiments of the present invention.

FIG. 14 illustrates a process of dye sublimation in accordance with some embodiments of the present invention.

FIG. 15 illustrates a color changing objects in accordance with some embodiments of the present invention.

FIG. 16 illustrates a UV triggered color changing objects in accordance with some embodiments of the present invention.

FIG. 17 illustrates a color changing objects in accordance with some embodiments of the present invention.

FIG. 18 illustrates a color changing wall in accordance with some embodiments of the present invention.

FIG. 19 illustrate a powder coating method in accordance with some embodiments of the present invention.

FIG. 20 illustrates an image piece immobilizing method in accordance with some embodiments of the present invention.

FIG. 21 illustrate a sublimated object manufacturing method in accordance with some embodiments of the present invention.

FIG. 22 illustrate a wall decorating method in accordance with some embodiments of the present invention.

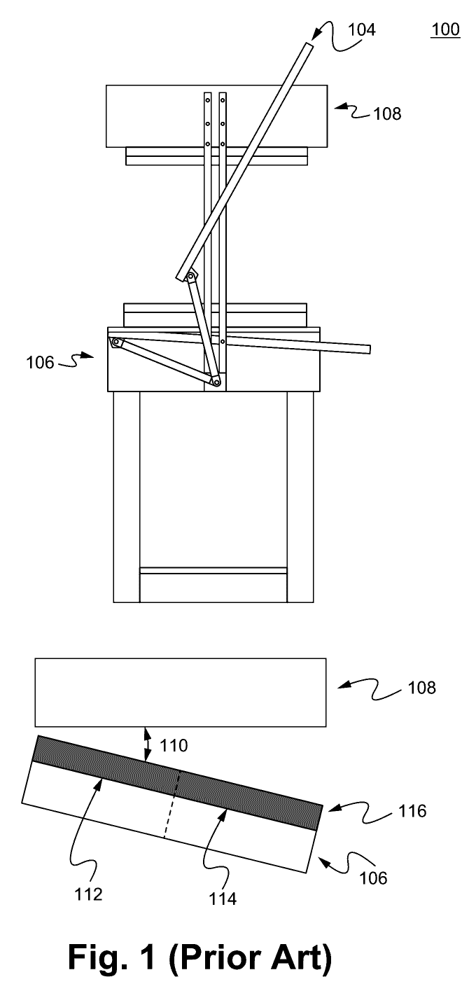

### DETAILED DESCRIPTION OF THE INVENTION

Method of and Device for Dye Sublimation with a Vacuum

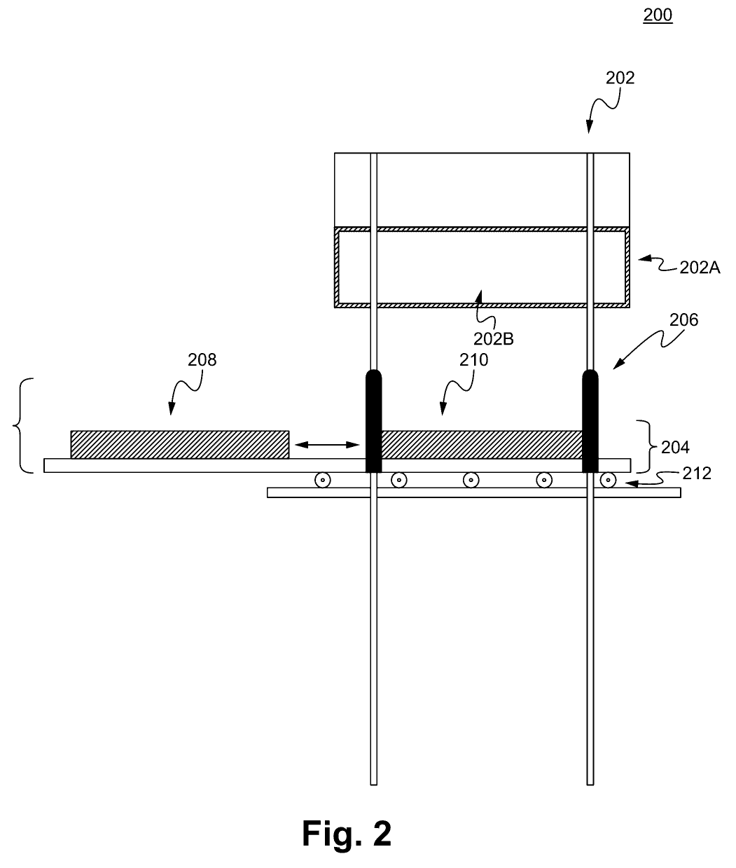

FIG. 2 illustrates a dye sublimation/transfer device 200 in accordance with some embodiments of the present invention. In some embodiments, the device 200 performs a vacuum sublimation process, which removes/sucks out gases to make a negative pressure on a vacuum tray. In some embodiments, the device 200 comprise a heating unit 202 and an object tray 204 (e.g., sublimation tray). The object tray can immobilize a sublimation film or sublimation paper having sublimation dye printed images with an object to be sublimated with the predetermined image. In some embodiments, the object has a layer of polymeric sublimation coating, such that the image can be sublimated onto the surface of the object. The device 200 can be used in a dye sublimation image transferring process.

In some embodiments, the object tray 204 comprises a replacement mechanism 212, such as wheel rollers, allowing a rapid tray replacement. For example, a tray 210 can be rapidly replaced by a tray 208 by rolling away the tray 210 and moving in the tray 208 forming a continuing and/or non-stopping shuttle style working line (e.g., one tray is for heating while the other tray is for preparing for the next round; two trays interchange system). In some embodiments, the loading tray 210 and 208 forms a whole unit allowing to shuttle back and forth by using the rollers 212.

In some embodiments, the heating unit 202 comprises heating elements (e.g., heating coils) enclosed by one or more heat insulating walls on the top side and four side walls of the heating unit 202. In some embodiments, extending insulating walls 202A are protruding from the heating unit 202 forming an empty space 202B or recess, which provides a more evenly heating environment. In some embodiments, the extending insulating walls 202A is between 0.8 feet to 1.5 feet. In some other embodiments, the extending insulating walls 202A has a height of 1 foot. In some embodiments, the heating unit 202 and the extending insulating walls 202A forms an integral unit moving up and down or vertically using the air or oil piston 206.

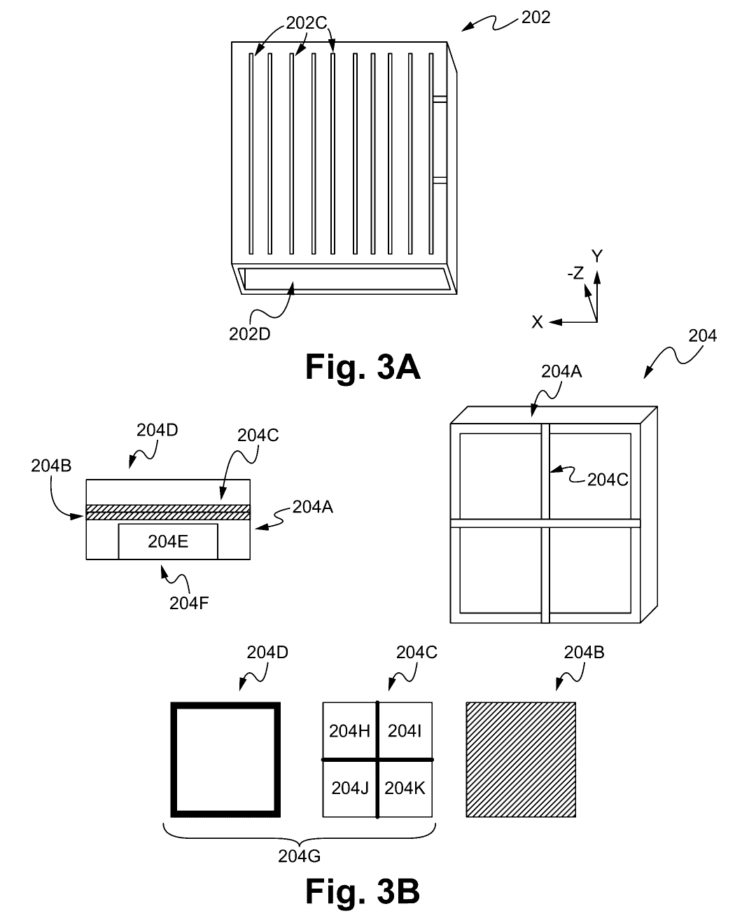

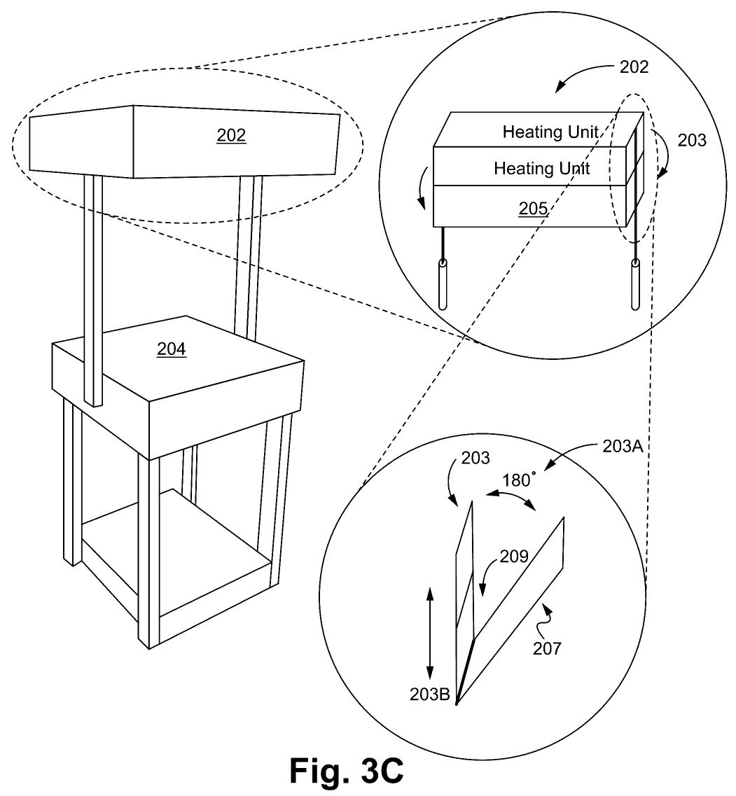

FIG. 3A illustrates a bottom view of the heating unit 202 in accordance with some embodiments of the present invention. In some embodiments, the heating unit 202 comprises one or more heating elements 202C (e.g., heating coils) on the bottom side of the unit 202, which is at a proximal side facing the tray 204. In some embodiments, the heating unit 204 comprises a body having empty space 202D for heat dissipation and for accommodating electrical wires.

FIG. 3B illustrates a loading tray 204 in accordance with some embodiments of the present invention. A side view 204F shows that the loading tray 204 comprises an upper frame 204D and a reinforced bars 204C forming a fixing structure 204G for immobilizing a film 204B, wherein the upper frame 204D is on top of the reinforce bars 204C, which is on top of the film 204B. The fixing structure 204G ensures that the film 204B remains at its position in each of the partitions 204H, 204I, 204J, and 204K while a heating process is applied (such as a sublimation heat transfer temperature at or over 120 C), such that position shifting or deformation of the film 204B in each of the partitions can be avoided or prevented. The 204E is a jig with an object to be sublimated with the film 204B at the lower chamber 204A. Under vacuum, the film 204B snag-wrap the object 204E (e.g., a cell phone case). The reinforced bars 204C provides a support/constrain force, such that the film 204B does not move.

In some embodiments, the loading tray comprises a metal tray. In some embodiments, the reinforced bar comprises a silicon rubber padding. A person of ordinary skill in the art would appreciate that any materials can be used to make the reinforced bar 204C so long as it does not melt or deform and able to immobilize the film 204B.

FIG. 3C illustrates an extendable enclosure 203 in accordance with some embodiments of the present invention. The extendable enclosure 203 can be similar to the extending insulating walls 202A of FIG. 2, which forms an evenly heating space 205. The extendable enclosure 203 can be expanded by flipping open a wing 207 or vertically sliding open a flap 209 forming an extended wall.

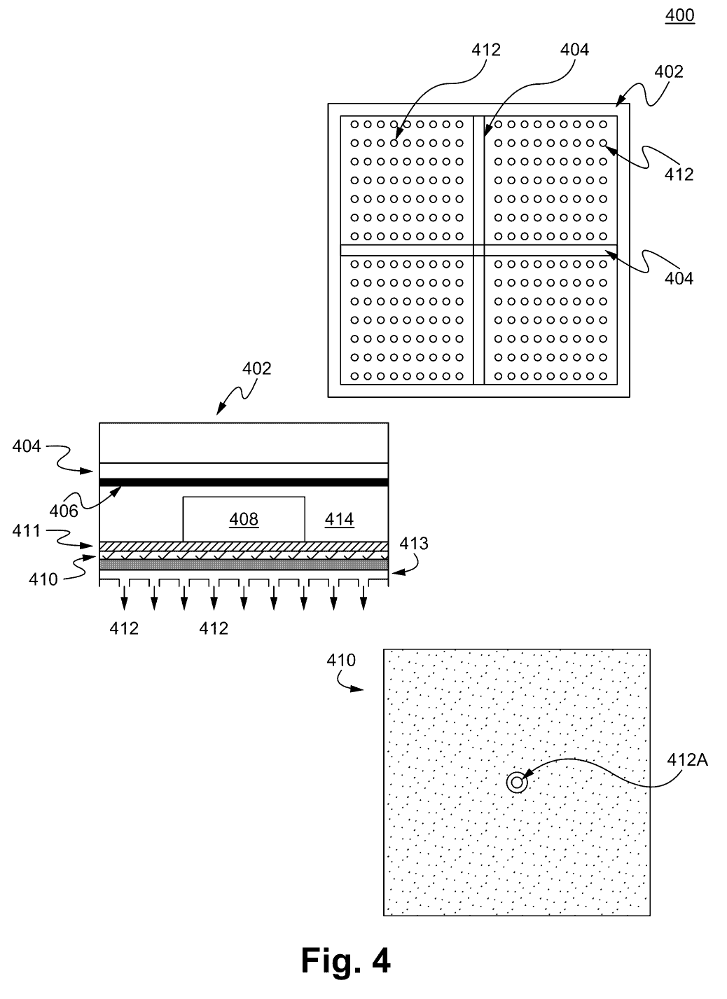

FIG. 4 illustrates a loading tray 400 in accordance with some embodiments of the present invention. When in use, a top fixing frame 402 presses against a reinforced frame 404, which presses against and immobilize a film 406. A negative pressure 412 (such as vacuum) is applied on the tray 400, such that the film 406 can attach/snag-wrap to the applying object 408 in a dye sublimation process.

In some embodiments, the tray 400 comprises a heat resistant felt 410, which can cover an entire surface of the tray 400 between a supporting and positioning metal plate 411 and the bottom surface 413 of the tray 400 where a negative pressure 412 is applied for generating a vacuum or suction force. The heat resistant felt 410 can be porous allowing air in the chamber 414 slowly and evenly removed through the negative pressure source (suction force) 412. The heat resistant felt 410 provides a stable air flow environment during the period of vacuuming at the air inlet/outlet 412A. In some embodiments, the thickness of the felt is ¼ inch.

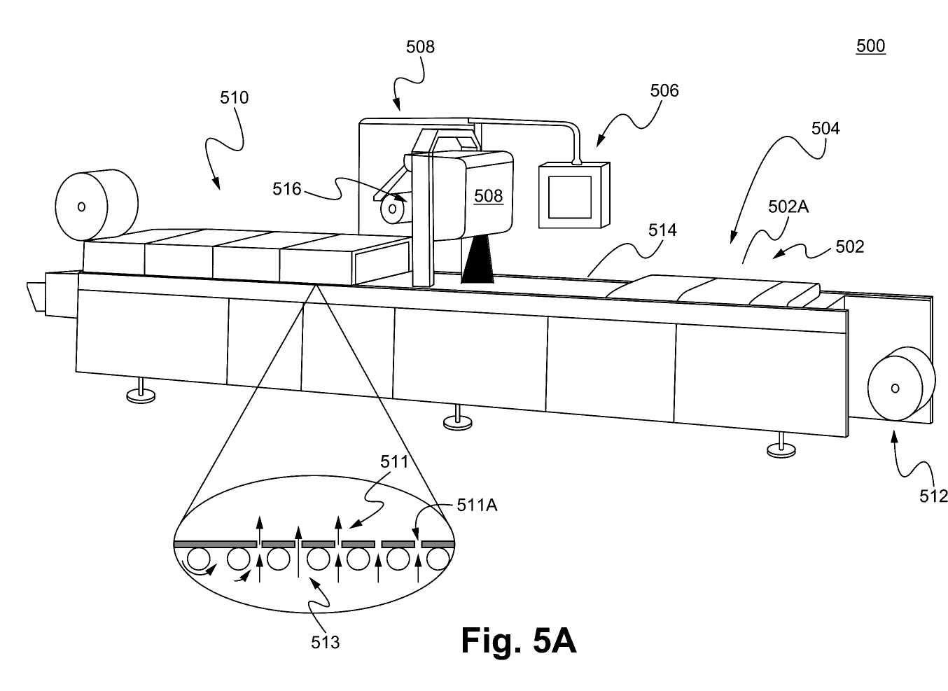

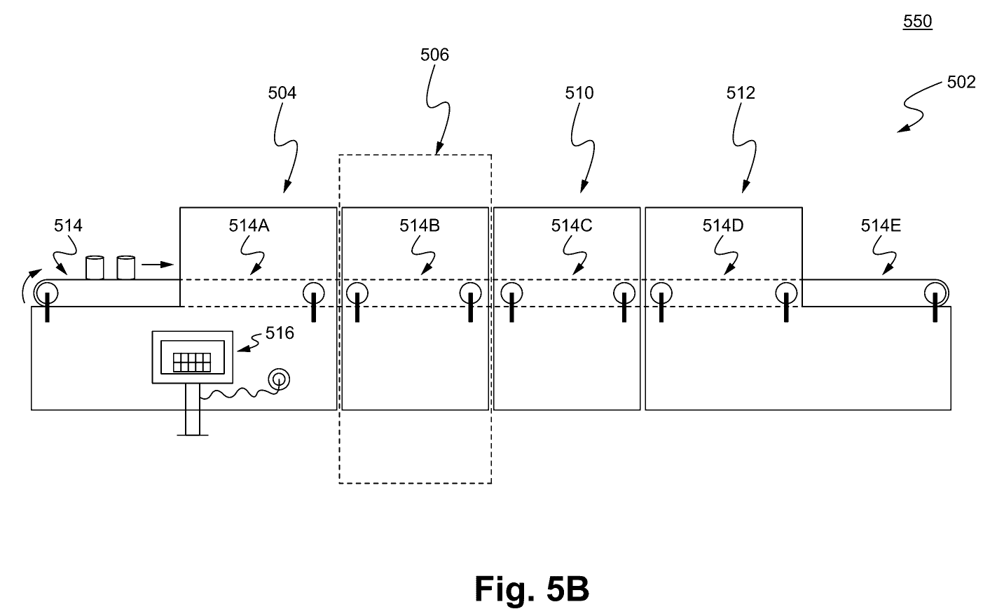

FIG. 5A illustrates a working station 500 in accordance with some embodiments of the present invention. A loading tray 502 is placed on the conveyer belt 514. A control panel 506 is able to control the temperature, pressure, transporting speed, and other controlling parameters. When the loading tray 502 arrive the first heating unit 508, a predetermined warming up time (such as 10 seconds) and strong & rapid negative pressure (such as −0.5 bar) are applied, such that the film 516 can be shrunk onto the applying object 502A on the tray 502. The warming can be performed using IR (infrared heater). The negative pressure can be an air suction unit forming a negative pressure on the side on the first heating unit 508 (e.g., an infrared light (IR) heater).

When the tray 502 arrives the heating tunnel 510, heating at or above a dye sublimation temperature (such as 120° C. or 140° C.) makes the dye sublimation to occur is applied. In some embodiments, the heating tunnel 510 comprises a flat and thin conveyor belt 511, which can be or similar to a Teflon containing belt. The belt 511 can be made by a heat resistant material. In some embodiments, the belt 511 comprises pores 511A allowing air stream 513 to flow through, which can be similar to the air flowing mechanism on an air hockey table. In some embodiments, the heating tunnel 510 and the loading tray 502 maintain a stable/steady and continuous vacuum environment through the pores 511A.

FIG. 5B illustrates a modularized working station 550 in accordance with some embodiments of the present invention. In some embodiments, the station 550 comprises heating elements, vacuum elements, or both in each of the modularized section 504, 506, 510, and 512. Each of the modularized sections 504, 506, 510, and 512 is able to be isolated and independently operated as a sublimation heating oven.

In some embodiments, the section 504 comprises a control panel 516, such that operational conditions (such as heating and/or vacuum durations, conveyance belt moving speed, temperatures) are able to be inputted or programmed for each section to be operated independently or operated as a whole. For example, an operator can setup four different heating temperatures for the entire working station 550 (such as, 100° C. for section 504, 130° C. for section 506, 70° C. for section 510, and 30° C. for section 512, which provides a heating profile including preheating, sublimation temperature, a first cooling temperature, and a second cooling temperature. The above gradually raising or lowering temperature profile reduces the failure rate due to a temperature difference shock. In another example, an operator s able to set a heating temperature for the entire working station 550.

The modularized working station 550 is able to add or remove sections based on production needs. For example, four sections 504, 506, 510, and 512 are used when a daily production quantity of 8,000 pieces are needed. Two sections of 504 and 512 (e.g., a head section and a terminal end section) are used when a daily production quantity 4,000 pieces are needed. The modularized working station 550 is able to add any addition sections (such as section 506) or remove any section based on a production need.

In some embodiments, a speed of the conveyance belt 514 is configured based on the numbers of the sections, such that the total heating duration is remain the same or not below a predetermined duration. For example, a base speed is used when two sections are used, and a 2 times of a belt speed is used when four sections are used.

In some embodiments, each of the belt sections 514A, 514B, 514C, 514D are able to be connected to form a continuous belt extending from the head section to the end section. The joining of the belts are able to be done by clipping the belt sections together or hooking meshed iron sheets. In some embodiments, each of the belt sections 514A, 514B, 514C, 514D are working independently at the same or different speeds. In some embodiments, the sections are directly connected, such as the section 504 is directly connect to the section 506 without a space between the sections. In some embodiments, some spaces are provided between the sections, adding additional belt sections to provide a continuous transportation.

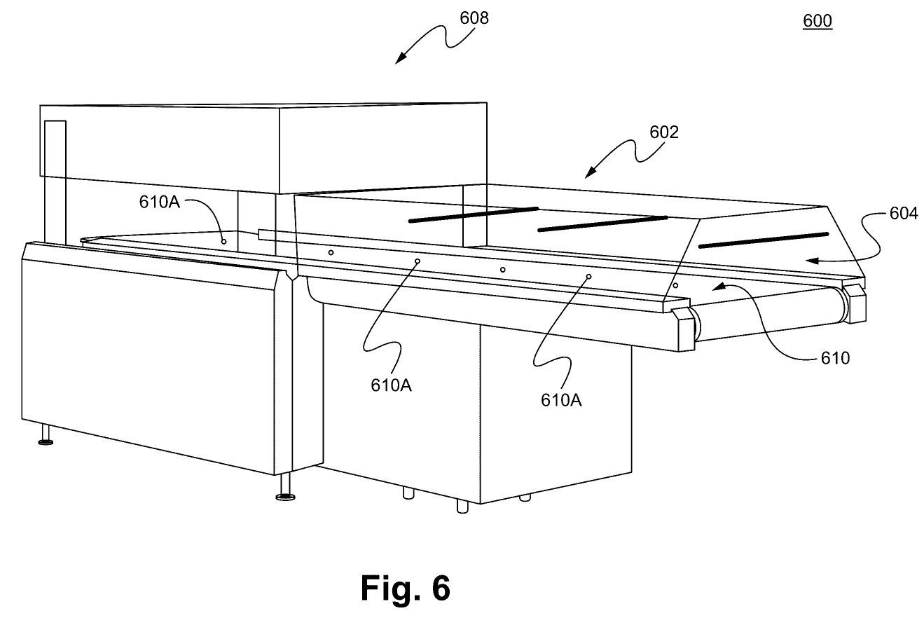

FIG. 6 illustrates another working station 600 in accordance with some embodiments of the present invention. The station 600 comprises a pre-heating area 602 having heating tubes 604 and a heating unit 608. The heating unit 608 is able to move up and down similar to the device 200 described in the FIG. 2. A tray with object for sublimation can be placed on the vacuum conveyor belt 610 to be automatically transported to be heated at the heating unit 608. Vacuum can be performed by connecting the vacuum adapter/holes 610A on the belt 610 to one or more pump.

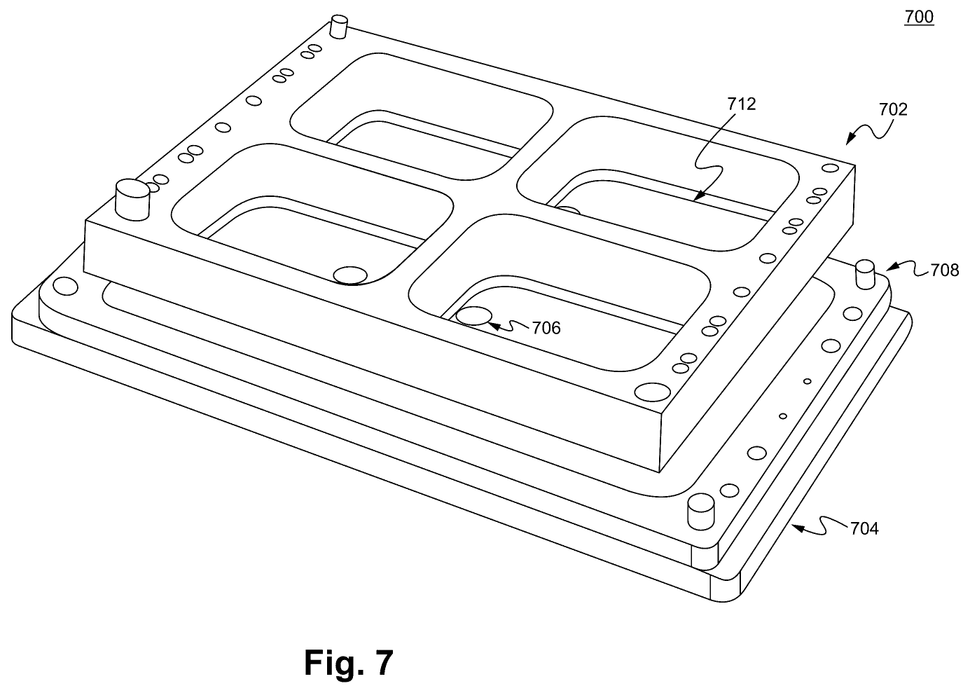

FIG. 7 illustrates a loading tray 700, which can be used in the station 500 and 600, in accordance with some embodiments of the present invention. The tray 700 comprises a top lid 702 and a bottom tray 704. The top lid 702 can comprise a fixed silicone reinforced bars 712 when subdividing one or more of the windows on the top lid 702 is selected. In some embodiments, the bottom tray 704 comprises removable/adjustable silicone seal frames/bars. One or more of the positioning posts 708 on the bottom tray can be used to position the top lid 702. A vacuum hole 706 can be on the bottom tray to form a negative pressure. In some embodiments, the bottom tray 704 can be used double sided. A film can be immobilized between the top lid 702 and the bottom tray 704 in a dye sublimation process.

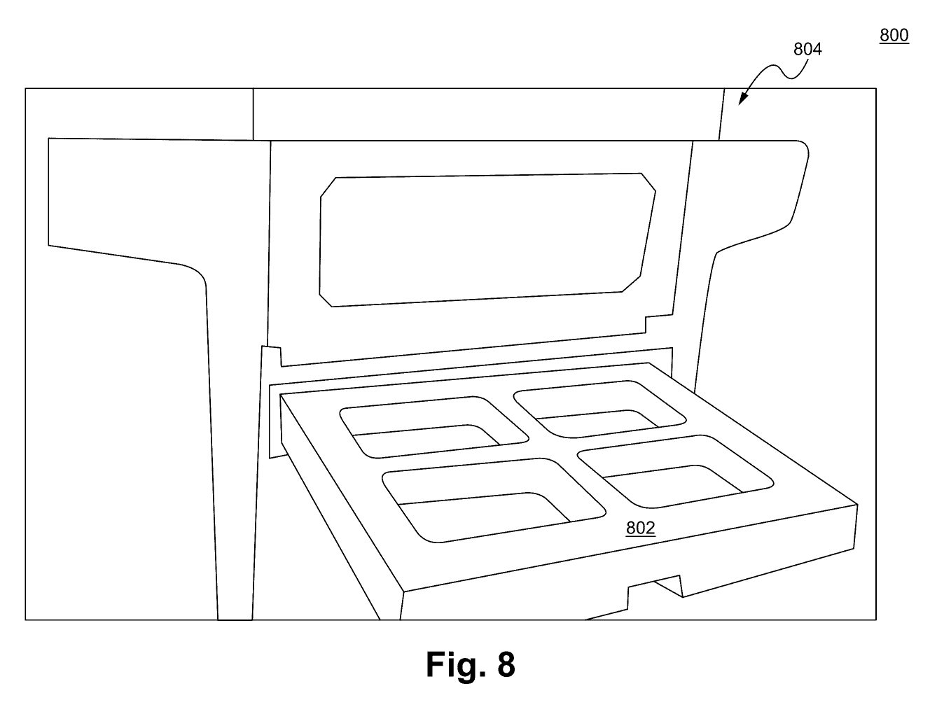

FIG. 8 illustrated an assembled loading tray 802 to be placed into an oven 804 for a dye sublimation process.

The methods and devices disclosed herein can be utilized in a dye sublimation process or heat transfer film process.

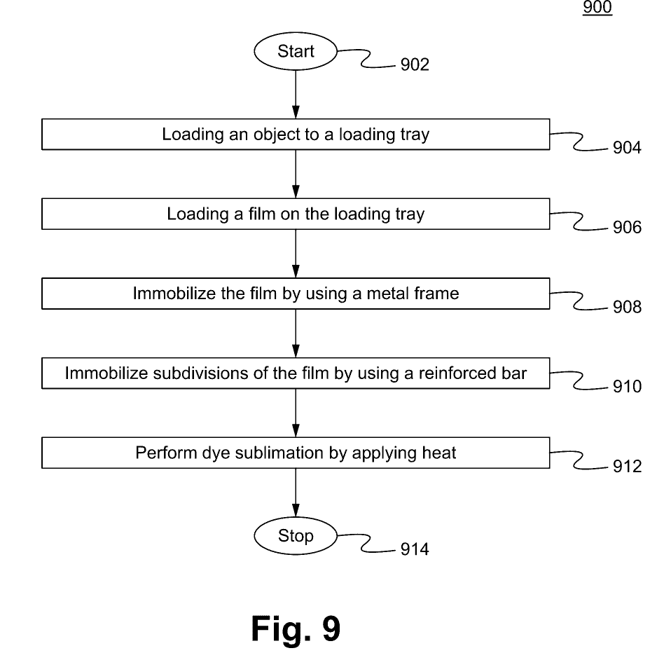

FIG. 9 is a flow chart illustrating a dye sublimation method 900 in accordance with some embodiments of the present invention. The method can start at Step 902. At Step 904, an object for applying a sublimation image is loaded to a loading tray. The object can be any substance to be applied with a custom image. For example, the object can be a tile, a piece of glass, a mug, a metal sheet, a mug, and a piece of cloth. A person of ordinary skill in the art will appreciate that any other substances can be used as the object. In some embodiments, the object is pre-coated with a layer of polymer, which allows the sublimated dye with a predetermined image to be fixed onto the object.

At Step 906, a film is loaded on the loading tray. The film can be a sublimation film (PC. TPU, Silicone, PU, PVC, ABS, PBT, PTT) or a heat transfer film (e.g., PVC, PE, PP, vinyl, silicone, TPU, ABS plastic). A person of ordinary skill in the art appreciates that the heat transfer film causes a layer of the film including the image to be transferred onto the object; whereas, the dye sublimation process causes the dye on the film to be transferred to the object.

At Step 908, the film is immobilized by using a metal frame. At Step 910, the subdivisions of the film is immobilized by using a reinforced bar, such as a silicone frame or a rubber frame.

At Step 912, a dye sublimation process is performed by applying heat/a predetermined temperature (such as 125 C). The method 900 can stop at Step 914.

In some embodiments, the method 900 can be performed by placing an object, placing a film immobilizing silicone bar based on the size of the object, placing film with dye printed image, and then placing the top cover to securely immobilize the film.

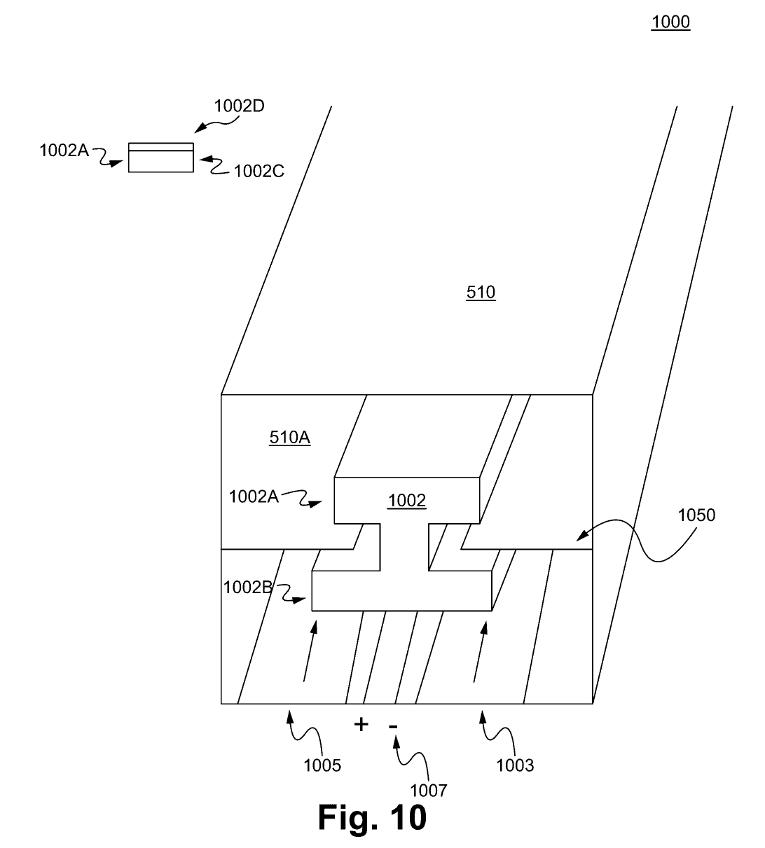

FIG. 10 illustrates a dye sublimation device 1000 in accordance with some embodiments of the present invention. In some embodiments, the device 1000 comprises a heating tunnel 510D (which can be the same or similar heating tunnel 510 in FIG. 5). The dye sublimation device 1000 can comprise a loading tray 1002. In some embodiments, the loading tray 1002 has a body in an “I” shape column. The top portion 1002A of the loading tray 1002 comprises a dye film 1002D (such as an image printed with the dye to be transferred to the object 1002C) attaching to the receiving object 1002C (such as a blank phone case with a layer of white polymer coating). The top portion 510A of the heating tunnel 510 provides a predetermined temperature (such as, 140 degree C.) for performing a dye sublimation process.

The bottom portion 1002B of the loading tray 1002 is able to be placed on one or more moving belts 1003 and 1005 for transporting/moving the loading tray 1002 moving in the heating tunnel 510. In some embodiments, the heating tunnel 510 comprises a DC supply 1007 (such as providing a 12V voltage for moving the loading tray 1002 and/or providing a power for an electrical vacuum pump 1014 of FIG. 11). In some embodiments, an AC supply is used to replace the DC supply 1007. In some embodiments, a heat insulation layer 1050, such as silicone, is used to separate the top portion 1002A and bottom portion 1002B.

FIG. 11 illustrates a loading tray 1002 internal construction in accordance with some embodiments of the present invention. The top portion 1002A of the loading tray 1002 comprises a transferring image film 1006 containing an image printed with a sublimation dye to be sublimated onto an object on the jig 1008. The jig 1008 comprises an image/dye receiving object on or inside the jig. The jig 1008 is able to be placed on a plate 1010, which is on top of felt 1012. A frame 1004 is able to be on top of the film 1006 for immobilizing the film 1006. In some embodiments, the frame 1004 comprises one or more partitions allowing to securing the position of multiple objects for the dye sublimation process concurrently.

In some embodiments, a pump 1014 is at the bottom side of the loading tray 1002, which provide a negative pressure environment to the top portion 1002A of the loading tray 1002. The pump is able to remove air in the top portion 1002A and pumps out the air through the side 1016 of the loading tray 1002. Thus, each of the loading tray 1002 can be individually vacuumed via the pump contained in each of the tray 1002. The pump can be powered by the electrical power supply 1007 via its power receiving points 1018A and 1018B.

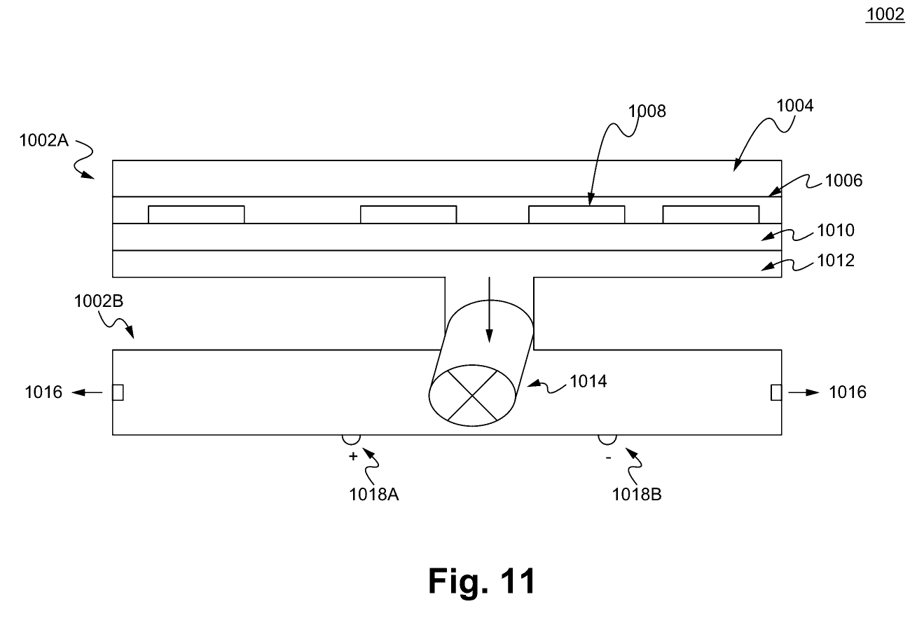

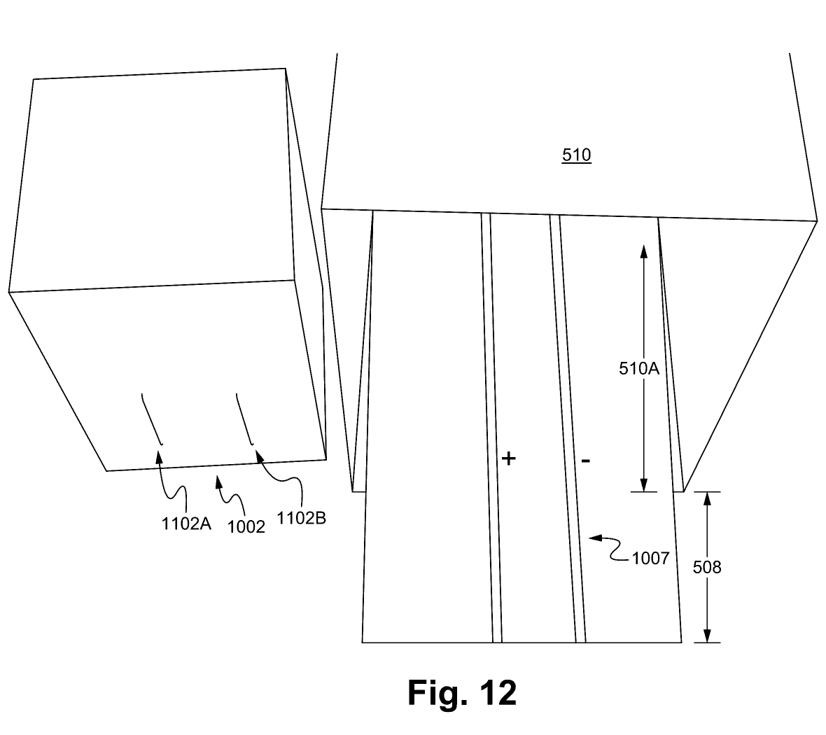

FIG. 12 illustrates the heating tunnel 510 in accordance with some embodiments of the present invention. In the FIG. 12, a voltage receiving tracks 1102A and 1102B are on the bottom of the loading tray 1102, which can be coupled with the electrical power supply 1007 by an electrical and/or physical coupling. Any materials that can be used to make a loading tray are within the scope of the present invention, such as metal tray, stainless tray, and silicone tray. In some embodiments, the loading tray 1002 is in a warming zone (pre-heating) 508 for 10 seconds with a first temperature (such as 120 or 140 degree C.), which is able to warm up the sublimation dye. In some embodiments, the loading tray 1002 is in the heating section 510A for 6-10 minutes with a second temperature higher than the first (pre-heating) temperature. The second temperature can be a temperature sufficient for a dye sublimation process to occur, such as 140 degree C. In some embodiments, a negative pressure is not applied in the warming zone 508 and is applied when the loading tray entering the heating section 510A. The negative pressure/vacuum is applied allowing a sheet with printing graphic design/picture with dye to tightly attach to the to-be printed/sublimated object. In some embodiments, the warming zone 508 does not contain the electrical power supply 1007.

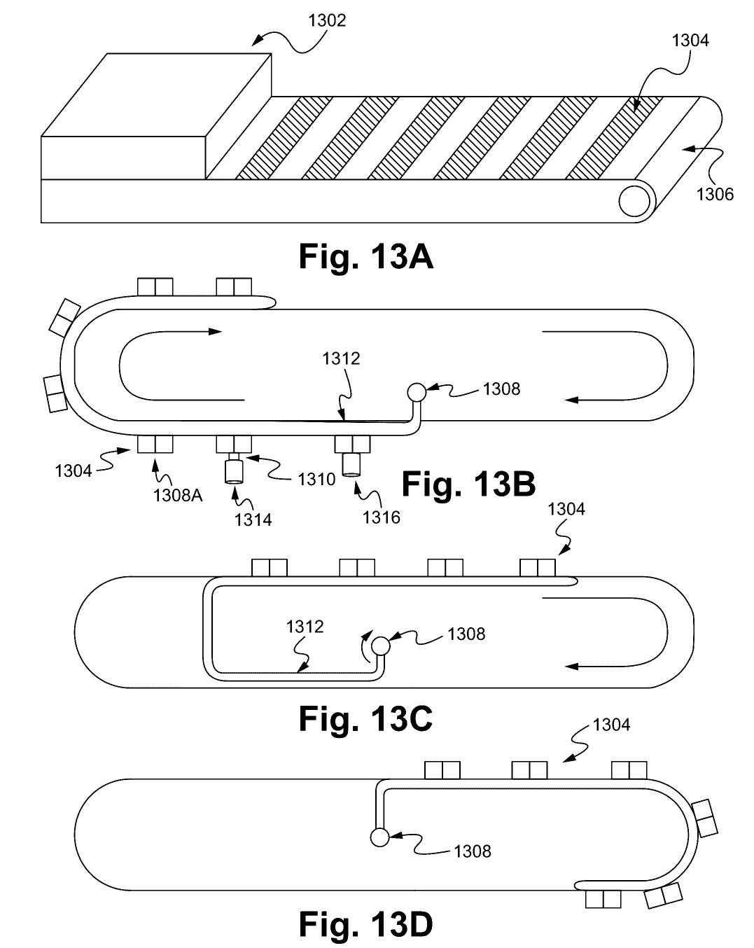

FIGS. 13A-13D illustrates a working station in accordance with some embodiments of the present invention. In some embodiments, the working station comprises a heating oven 1302 with a conveyer belt 1306. In some embodiments, the working station comprises one or more cooling/freezing device to lower a temperature of an object or to cause a temperature shock due to a temperature differences.

In some embodiments, the conveyer belt 1306 comprises one or more moving plate 1304, which is fixed or instantly attachable/detachable with the conveyer belt 1306. The moving plate 1304 can move along with the movement of the conveyer belt 1306.

FIGS. 13B-13D further illustrate an internal construction and an operation mode of the conveyer belt 1306. As shown in FIG. 13B, the conveyer belt 1306 comprises a pump connector 1308, which provides a vacuuming source or a negative pressure. In some embodiments, a tube 1312 is connected with the pump connector 1308. The tube couples with/attaches to one or more of the moving plates 1304. In some embodiments, the tube 1308 is under a negative pressure, such as vacuum. In some embodiments, the tube 1308 is under a positive pressure, such that a push force can be provided.

In some embodiments, the plate 1304 contains a channel 1308A, and a suction force and/or a push force can be provided via the channel 1308 based on the pressure status at the pump connector 1308. In some embodiments, tools (e.g., clamps) and adaptors 1310 are coupled to the plate 1304, such that a structure of the tools and adaptors 1310 can be used to pick up an object, such as a mug 1314. In some embodiments, the moving plate 1304 is able to pick up an object directly using the suction force provided at the channel 1308.

FIG. 13C shows that the tube 1312 travels further in a clockwise direction than the tube 1312 in FIG. 13B. In some embodiments, the tube 1312 comprises a soft and/or bendable tube, such as a silicone tube. FIG. 13D shows that the tube 1312 travels further than the tube 1312 in FIG. 13C, which also shows that the tube 1312 also rotates along the rotating point of the pump connector 1308. The rotatable structure of the tube 1312 and the pump connector 1308 make the tube 1312 capable of endlessly rotating along the center of the pump connector 1308 without a need to re-connect the tube 1312 after it turns more than a circle.

In operation, the present invention can perform preheating, forming a vacuum environment allowing a film with dye to snug-fit an applying object, applying and maintaining a temperature for a predetermined duration allowing a process of sublimation for the dye to be transferred to the object, and removing the film before the object cools down.

Color Changing Surfaces Using a Dye Sublimation Process

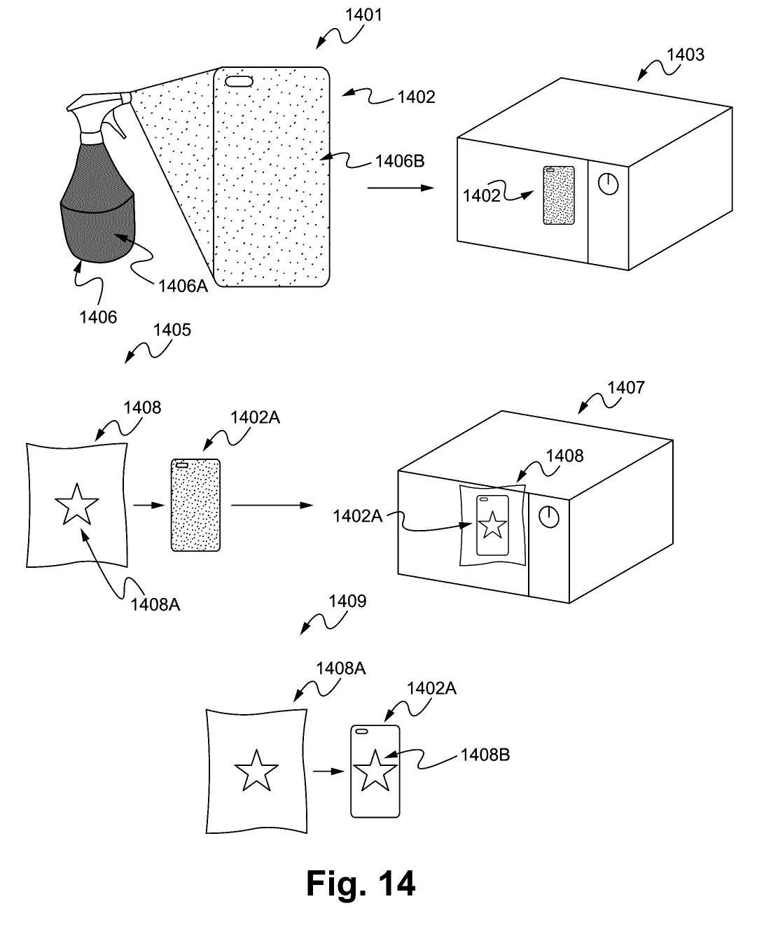

FIG. 14 illustrates a process 1400 of dye sublimation in accordance with some embodiments of the present invention. In some embodiments, the process 1400 starts at a Step 1401. At the Step 1401, a coating composition 1406 in a solvent 1406A is applied/sprayed on an object 1402, such as a cell phone case. In some embodiments, the Step 1401 forms a uniform coating layer 1406B on the object 1402.

In some embodiments, the coating composition 1406 comprises a first amount of polyurethane, a second amount of curing compounds/agents or hardening agent (e.g., MOCA [4,4′-Methylene bis-(ortho-chloroaniline)]), a third amount of thermalchromic pigment (e.g., [(CH₃CH₂)NH₂]CuCl₄) and a fourth amount of a solvent (e.g., dimethylbenzene/xylol and butanone). In some embodiments, the ratio by weight of the first amount, the second amount, the third amount, and the fourth amount is 3:1:0.25:1. In some embodiments, the ratio by mole number of the first amount, the second amount, the third amount, and the fourth amount is 3:1:0.25:1.

In some embodiments, the thermalchromic pigment can be selected with a triggering condition, such as selecting a pigment that changes its color at a predetermined temperature, for example, human body temperature 38° C., room temperature 25° C., ice freezing point 0° C., or any other predetermined temperature. In some embodiments, a chromic pigment added is selected to be UV sensitive, such that the color changing condition can be a predetermined strength of a light, for example, UV index 10 or a sun safe UV index. In some embodiments, the chromic pigment is selected to be a moisture sensitive compound or a mixture (e.g. CaCl₂ contained), such that the color changing condition can be a degree of moisture in the air.

In some embodiments, the polyurethane is replaced by or used along one or more epoxide based and/or epoxy resin compounds. In some embodiments, the hardness, brightness, and adhesiveness can be enhanced or strengthened by adding one or more nanoparticles (e.g. nanoparticles of silicon oxide (SiO₂), aluminium oxide (Al₂O₃), and/or chromium (III) oxide (CrO2)). In some embodiments, the nanoparticles are in the composition from 0.3%-10% by weight. In some embodiments, the nanoparticles have an average size equal or less than 200 nm. In some other embodiments, the nanoparticles have an average size equal or less than 15 nm.

In some embodiments, the composition further comprises UV resistant agent. The UV resistant agent can be UV resistant resin (e.g., Rynite® 935SUV, which is a 35% glass-fiber/mineral reinforced, UV stabilized grade of polyethylene terephtalate (PET); and Rynite® 540SUV, which is a 40% glass-fiber reinforced, UV stabilized grade of PET). Any other compounds that can be chemical resistant, high-abrasive material, anti-friction material, abrasion resistance, resistance to wear, and resistant to wear and tear are within the scope of the present invention.

At a Step 1403, the object with the layer of coating layer 1406B is baked/heated in an oven or is exposed under a UV curing light for a predetermined duration and at a predetermined temperature forming a coated object 1402A. For example, the object 1402 with coating 1406B is heated at a temperature between 70° C. and 150° C. (e.g., 80° C.) for 50 minutes. A person of ordinary skill in the art appreciates that any other duration of heating/baking is within the scope of the present invention, such as from 20 minutes to 3 hours.

At a Step 1405, a sublimation sheet with a sublimating dye printed image 1408A is attached/coupled with the coated object 1402A. The material of the sublimation sheet (dye sheet) can be paper, TPE (Thermoplastic elastomers), PC, TPU, Silicone, PU, PVC, ABS, PBT, PTT and any other substrate that allows the dye to be absorbed and subsequently transferred onto a coated surface under a heat, vacuum, or a combination thereof.

At a Step 1407, the sublimation sheet coupled coated object 1402A is heated in an oven for a predetermined temperature and duration, such as 140° C. for 5 minutes. The heating temperature and duration varies based on different materials of the object. For example, if the object is a plastic, the heating duration and temperature can be shorter and lower than if the object is a glass based material.

At a Step 1409, the sublimation sheet 1408 is peeled away from the coated object 1402A with dye transferred image 1408B. The dye transferred image 1408B is absorbed onto and becomes a part of the coated object 1402A.

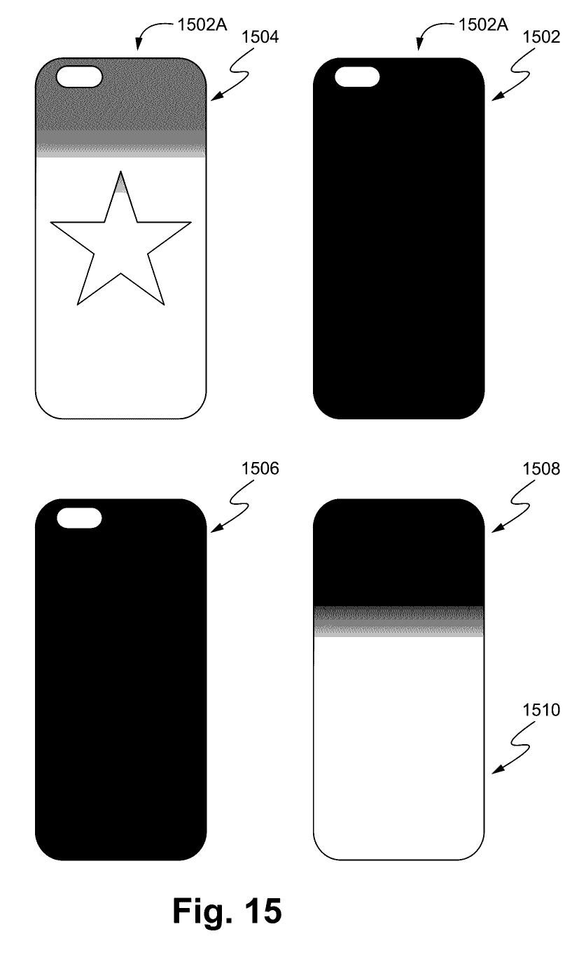

FIG. 15 illustrates a color changing objects 1500 in accordance with some embodiments of the present invention. In some embodiments, the object 1502 is coated with a thermal color changing coating that configured to have a composition changing color at 38° C. As shown, the object 1502 comprises a dark color surface. When a temperature is higher than 38° C., the surface 1502A becomes an object 1504 having a semi-transparent/transparent coating, such that the background image (e.g., the girl) is more visible. In some embodiments, the color changing dye can completed obscure/hide the image at the background at a lower temperature and show/reveal the image when a temperature higher than the color changing temperature of the color changing coating. In some embodiments, the color changing coating shows a dark/solid color at a higher temperature (30° C.) and shows a more transparent color at a lower temperature (e.g., −10° C.).

A phone case 1506 shows a dark color (e.g., dark red, dark blue, black, or deep green) at a lower temperature (e.g., 10° C.) and changes its color to be a more light color or white color when the lower portion 1510 of the case 1506 receives a hand temperature around 38° C. As shown, the top portion 1508 remain the same color when only the lower portion 1510 is heated. In some embodiments, the color changing process triggered by different temperatures are reversible processes. In other words, when a temperature is higher than a predetermined temperature, a first color changes to a second color. When a temperature drops back to be lower than the predetermined temperature, the color changes back to the original first color. In some other embodiments, the color changing dye employs a dye that change its color only in one direction. For example, when a temperature is higher than a predetermined temperature, a first color changes to become a second color. When the temperature drops back to lower than the predetermined temperature, the color stays at the second color.

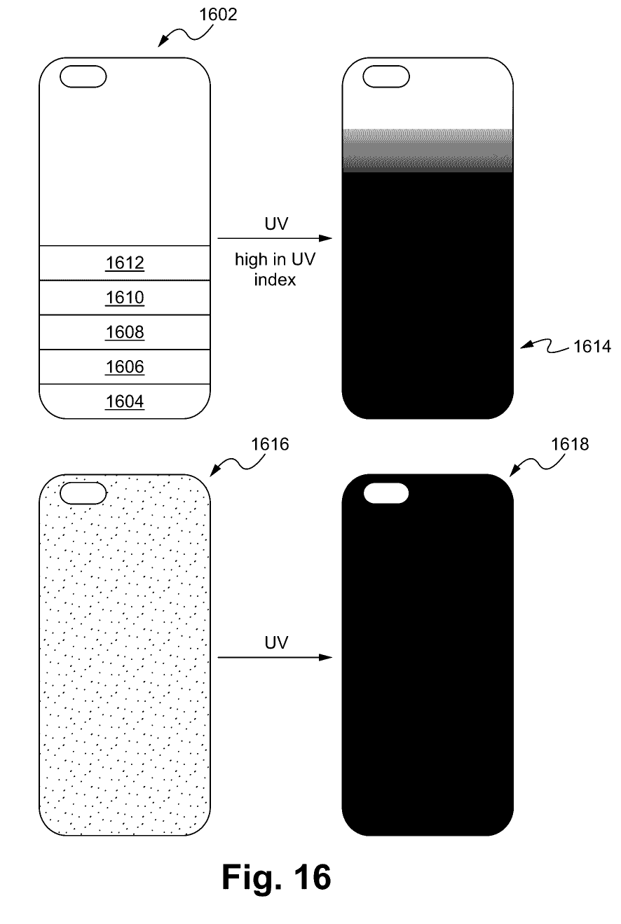

FIG. 16 illustrates a UV triggered color changing objects 1600 in accordance with some embodiments of the present invention. A phone case 1602 is coated with a UV triggered color changing coating. The case 1602 comprise zones 1604, 1606, 1608, 1610, and 1612. Each of the zones 1604, 1606, 1608, 1610, and 1612 comprises different density of UV sensitive compounds, such that each of the zones changes color at different UV strength. In some embodiments, the zone 1604 changes color when expose to a UV light with an index number of 1-2 (low UV level) (based on US Environmental Protection Agency (EPA) standard). The zones 1606, 1608, 1610, and 1612 change colors when expose to a UV light with an index number of 3-5 (moderate level), 6-7 (high level), 8-10 (very high), and 11+ (extremely high) respectively. The zones provides a UV level indication function, such that a user can use it to take proper protection measure when going outdoors.

In some embodiments, a phone case 1616 is coated with a UV sensitive coating to change a color when a UV level is higher than a predetermined level, such as higher than 5 in the UV index number, so a user is able to know that an UV level is exceed the moderate level when a color change occurs on the phone case.

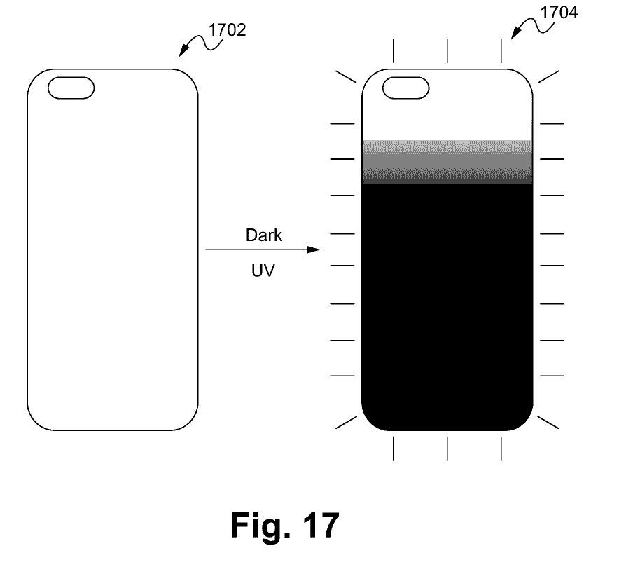

FIG. 17 illustrates a color changing objects 1700 in accordance with some embodiments of the present invention. The case 1702 is coated with a fluorescence and/or a phosphorescence coating, such that the coating is able to show a lighting effect 1704 when in dark and/or when applying a UV light.

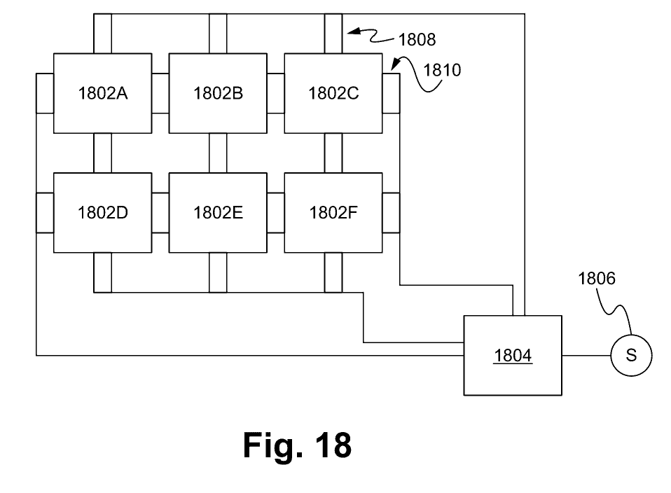

FIG. 18 illustrates a color changing wall 1800 in accordance with some embodiments of the present invention. The tiles comprises a thermal color changing coating. At the back side of the tiles 1802A-1802F, heating wires 1808 and 1810 couple with the tiles 1802A-1802F. A controller 1804 powered by the power source 1806 controls the temperature on each of the tiles 1802A-1802F. In some embodiments, each of the tiles 1802A-1802F comprises a temperature sensor and/or any other sensors (such as moisture sensors), such that the controller is able to individually control the heating or any other controlling actions/motions on each of the tiles. The color changing wall 1800 by using the controlling method described above and with the color changing tiles is able to change its color by flipping a power/controlling switch.

In some embodiments, the coating comprises phosphorescence, fluorescence, and/or glow-in-the-dark dye. In some embodiments, the color dye that is used for image printing includes some of the materials included in the coating, such as phosphorescence, fluorescence, and/or glow-in-the-dark dye, nanoparticles, and UV dye.

Powder Coating Method

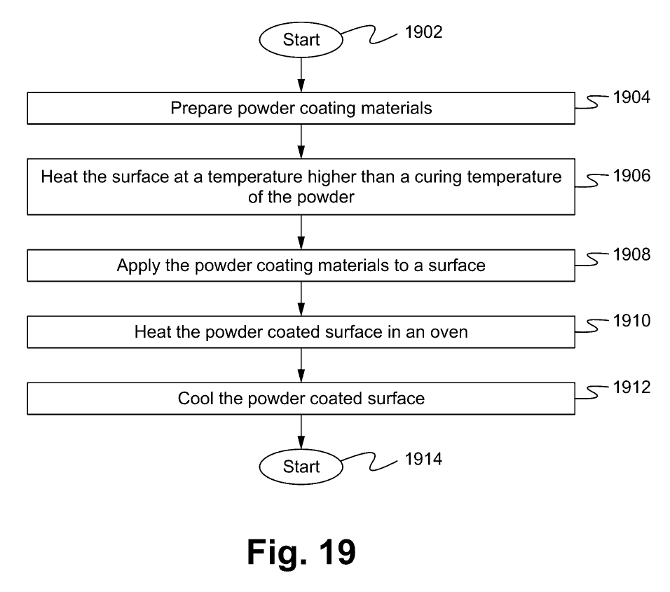

FIG. 19 illustrate a powder coating method 1900 in accordance with some embodiments of the present invention. The method 1900 can start from a Step 1902. At a Step 1904, powder coating materials/chemical reagents or reactants are prepared. In some embodiments, the powder coating materials are prepared by adding 3%-5% by weight of color fixing agent to a powder. In some embodiments, the powder comprises a thermoplastic or a thermoset polymer. In some embodiments, the powder comprises polyurethane. In some embodiments, the powder are clear powder coating. In some embodiments, the powder are commercially available powders, such as Columbia Mirror Yellow form Columbia Coatings or DECORAL® are used. Any other chemicals that can be used to form a coating for sublimation of an image are within the scope of the present invention. In some embodiments, the color fixing agent is in a range of 3%-10% by weight in the powder mixture. The color fixing agent makes a surface having the powder coating capable of having a high image resolution/sharp and crisp image of a sublimated image. In some embodiments, the color fixing agent comprises a high pH chemical, such as a sodium carbonate (soda ash) and sodium hydroxide (caustic soda). In some embodiments, property enhancing chemicals are added to the powder. For example, aluminum oxide nanoparticles having an average particle size in the range of 10 nm-200 nm are added to the powder to enhance to scratch resistance property of the surface that is prepared.

At a Step 1906, heating the object, such as using an oven, with the surface for sublimation coating at a temperature 10-20 C higher than the cure time of the power or polymer for a predetermined duration, such as 20 minutes.

At a Step 1908, the powder coating materials are applied to a surface, such that the surface comprises chemical constituents/composition capable of receiving/having a sublimated image or photo with clear photo quality (e.g., clarity of a photo quality that is acceptable by an average person). In some embodiments, the powder coating is able to be applied on the surface by using a powder spraying gun/powder gun. In some embodiments, the surface is cleaned/treated by sandblasting, scrubbing to remove coatings or oils, and/or applying simple green to clean the surface. In some embodiments, the surface comprises a surface of a mug, a surface of a metal sheet, a surface of a glass, and a tile surface. Any objects with a surface that can be used to make a sublimation image are within the scope of the present invention.

At a Step 1910, heat the power coated surface in an oven at a temperature equal or higher than the curing temperature of the powder, such that the powder melts or cures to be immobilized on the surface. The heating can be performed with a predetermined duration, such as 10-20 minutes, or a duration sufficient for the 90% of the powder to be cured.

At a Step 1912, the powder coated surface is cooled for 30-40 minutes. The method 1900 can stop at a Step 1914.

Home Décor Using Sublimation Methods and Objects

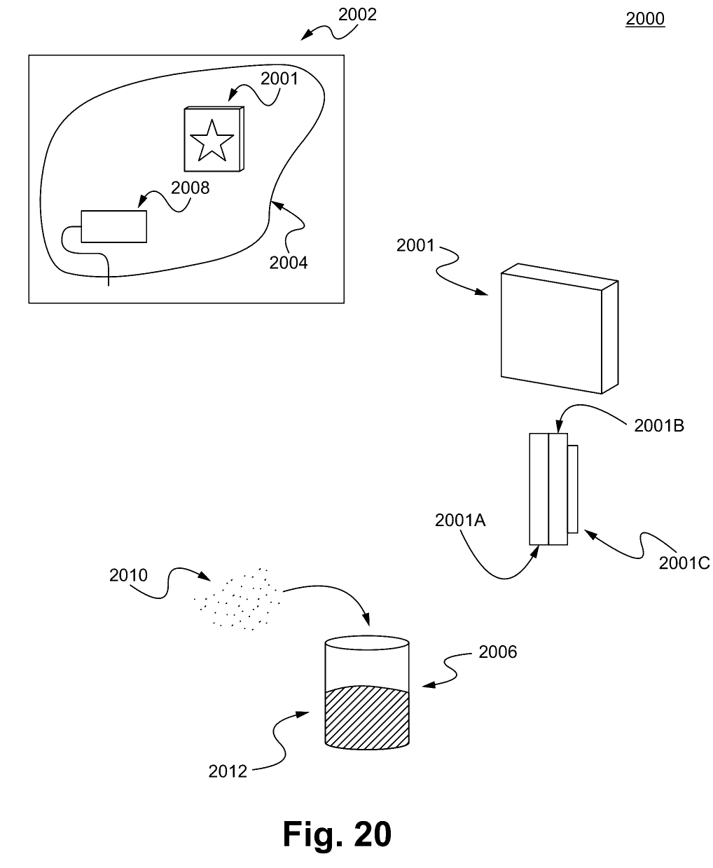

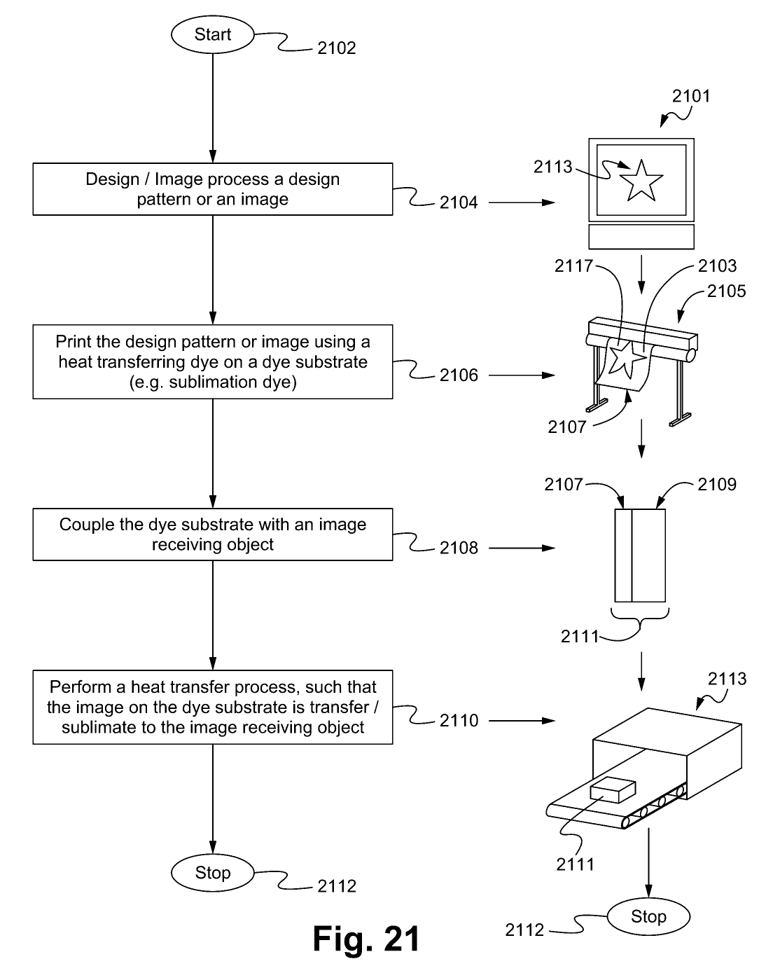

FIG. 20 illustrates an image piece immobilizing method 2000 in accordance with some embodiments of the present invention. In some embodiments, the method 2000 comprises having an object 2001 coupling with a structure 2002 through a magnetic force. The structure is able to be a wall, a dry wall, a structure with magnetic property such that a ferric or iron containing material can be attached, and a structure with iron or ferric material such as an iron/aluminium/metal sheet.

In some embodiments, a magnetic coating 2004 is applied on the structure 2002, such that the structure 2002 is able to magnetically attach the object 2001. In some embodiments, the magnetic coating is formed by applying a magnetic paint on the structure 2002 using a paint roller 2008. The magnetic paint can be formed by mixing an oil based or water based paint 2006 with metallic powder 2010 forming the magnetic paint 2012, which is applied on the structure 2001 forming the magnetic coating 2004. In some embodiments, the magnetic paint 2012 is applied on one or more predetermined locations on the structure 2002, such that the structure 2002 comprises selected areas with magnetic attractive property and some selected areas without such property.

In some embodiments, the object 2001 comprises a base material 2001A having a layer of coating 2001B. An image 2001C is able to be sublimated on the coating 2001B. In some embodiments, the coating 2001B comprises a polymeric coating, such as a polyurethane based coating, a function enhancing material (such as nanoparticles to enhance reflective), and/or magnetic or metallic powders/solutions.

FIG. 21 illustrate a sublimated object manufacturing method 2100 in accordance with some embodiments of the present invention. The method 2100 can start at a Step 2102. At a Step 2104, a design pattern and/or an image 2103 is designed or processed on a computer 2101.

At a Step 2106, the design pattern or image 2103 is printed on a dye substrate 2117 using a heat transfer dye/ink using a printer 2105, such that the image 2103 is printed on the substrate 2117 forming an image printed sheet 2107. In some embodiments, the dye transfer ink comprises a dye sublimation ink. In some embodiments, the dye substrate comprises a sublimation paper or polymeric film.

At a Step 2108, the image printed sheet 2107 is coupled with an image receiving object 2109 forming a pre-transfer object 2111.

At a Step 2110, a heat transfer process is performed, such that the image receiving object is printed/sublimated with the predetermined image 2103. The image receiving object 2109 is placed in an oven 2113 (such as a dye sublimation oven) for a heat transfer/dye sublimation process. The method 2100 can be stop at a Step 2112.

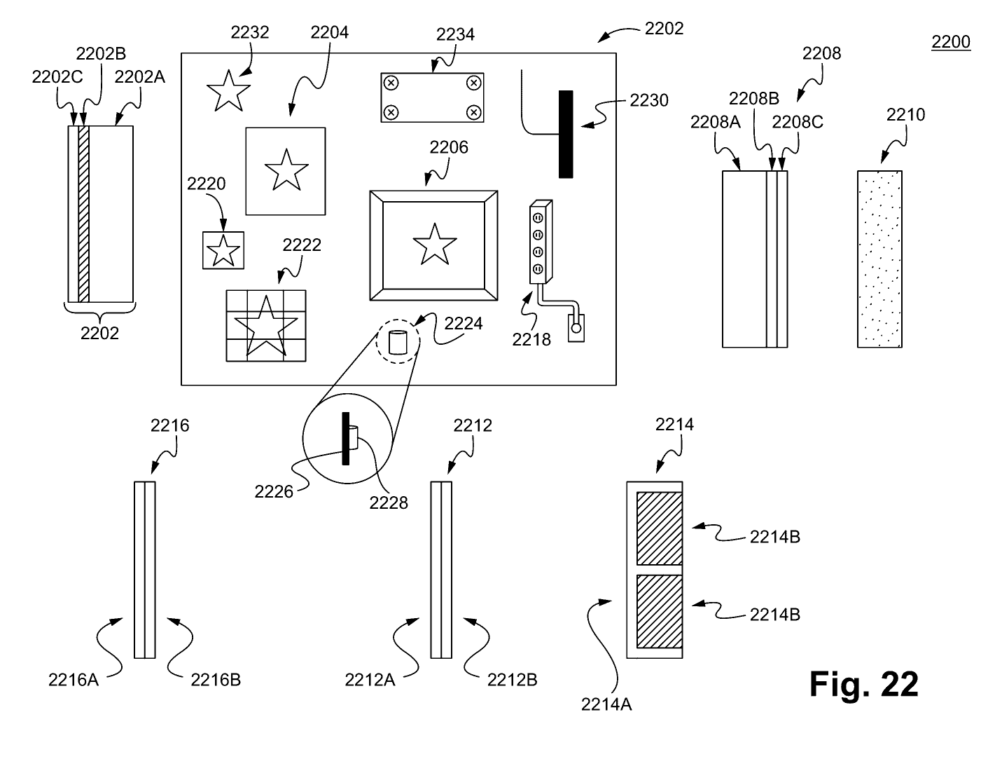

FIG. 22 illustrate a wall decorating method 2200 in accordance with some embodiments of the present invention. In some embodiments, a structure 2202 comprises a dry wall 2202A, which is painted over with a functional paint (such as, a metallic paint or a magnetic paint 2202B). A finish paint 2202C is painted over the functional paint 2202B. In some embodiments, the finish paint 2202C comprises a fluorescence paint and/or a blackboard paint. In some embodiments, the structure 2202A comprises a metallic sheet without a functional paint 2202B painted over, wherein the metallic sheet can be covered by wall paper.

In some embodiments, either one or both of the structure 2202 and object 2232 comprises magnetic properties, such that the object can be immobilized or attached on the structure via a magnetic force. In some embodiments, a refrigerator magnet printed or sublimated with an image 2204 is able to be attached with the structure 2202. In some embodiments, a metal sheet 2234 is fixed on the structure 2202 via nails or screws, such that a sublimated photo, tile, glass block can be attached to the metal sheer 2234 via magnets at the back or front side of the sublimated photo, title, or glass block. In some embodiments, a sublimated photo metal plate with a wood frame 2206 is attached to the structure 2202 via magnetic force with magnets embedded in the frame and/or the metal plate. In some embodiments, a single tile 2220 or titles 222 puzzled together to form a completed photo or figure is attached to the structure 2202 via magnetic force or glue, wherein the photo or image on the tile are formed by using an image sublimation process. In some embodiments, functional objects such as power outlet strip 2218, hangers 2230, kitchenwares are attached to the structure 2202. In some embodiments, a half cut mug 2224 is attached to the structure 2224 as a wall décor. The half cut mug comprise a half cut mug 2228 attached with a magnet sheet 2226.

In some embodiments, the object that can be attached with the structure 2202 comprises a body 2216 having a surface 2216A attached/glued with magnet 2216B. The surface can be any printable/sublimatable surface, such as paper surface, polymer, silicone, and wood. In some embodiments, tiles 2208, 2210, 2212, and 2214 are able to be attached with the structure 2202 via a magnetic force. For example, the tile 2208A is coupled with one or more magnets/magnet sheet 2208C via glue 2208B. The glue is able to be a pressure sensitive adhesive. The tile 2210 comprises a ceramic body mixed with an amount of magnetic powder or metallic powder, which are homogeneous in some cases and having a higher density of the magnetic/metallic powder in some preselected areas. The tile 2212 comprises a reduced thickness ceramic tile glued or clipped on the magnets 2212B. The reduce thickness ceramic tile can be made by cutting a regular thickness tile or manufactured with a reduced thickness. In some case, the reduced thickness tile have a thickness not enough to withstand a hand punch on a table, such as a thickness like a paper. The reduced thickness tile is able to reduce the weight of the tile. In some embodiments, the tile 2214 comprises a structure with one or more recess or apertures 2214A for placing magnets 2214B.

In some embodiments, a sublimation coating is sprayed onto a structure, such as a wall directly. A sublimation paper or film printed with one or more predetermined images is attached to the wall. A heating device, such as a handheld heating plate is pressed on or above the sublimation paper or film, such that the image is transferred/sublimated onto the wall.

In operation, the present invention can perform by preparing a coating composition in a solution, spraying on a surface of an applying object, and baking at a temperature (e.g., 80° C.) for a predetermined duration (e.g., 50 minutes). The present invention can be utilized to make color change walls, UV detection device, and temperature indication devices.

A color changing coating composition comprises a first amount of polyurethane, a second amount of curing compounds/agents or hardening agent, a third amount of thermalchromic pigment, and a fourth amount of a solvent.

The description is presented to enable one of ordinary skill in the art to make and use the invention. Various modifications to the described embodiments are readily apparent to those persons skilled in the art and the generic principles herein can be applied to other embodiments. Thus, the present invention is not intended to be limited to the embodiments shown but is to be accorded the widest scope consistent with the principles and features described herein. It is readily apparent to one skilled in the art that other modifications can be made to the embodiments without departing from the spirit and scope of the invention as defined by the appended claims.

What is claimed is:

1. A sublimation system comprising:
a) a heating unit;
b) a transporting unit having a vacuum element;
c) a control unit controls the heating unit, the transporting unit, or both.

2. The system of claim 1, wherein the transporting unit comprises a conveyer belt.

3. The system of claim 1, wherein the vacuum element comprises a tube revolving along the transporting unit.

4. The system of claim 1, wherein the heating unit is configured to heat at a press down motion.

5. The system of claim 1, wherein the vacuum element is on each of loading trays.

6. A sublimation system comprising:
a) a first section with a first heating element and a first transporting element; and
b) a second section with a second heating element and a second transporting element, wherein the first section is able to be connected with the second section forming an extended sublimation system.

7. The system of claim 6, wherein the first transporting element comprises a structure for joining the second transporting element forming an extended transporting unit.

8. The system of claim 7, wherein the extended transporting unit comprises a conveyer belt.

9. A sublimation system comprising a loading tray having a subdividing frame.

10. The system of claim 9, wherein the subdividing frame is configured to immobile a sublimation sheet.

11. The system of claim 10, wherein the sublimation sheet comprises at least two separated images printed using a sublimation dye.

12. The system of claim 9, wherein the loading tray comprises a vacuum hole.

13. The system of claim 9, wherein the subdividing frame comprises at least three cavities.

14. The system of claim 9, further comprising a bottom tray having positioning post locking a position of the subdividing frame.

15. The system of claim 14, wherein the bottom tray comprises a vacuum hole.

16. A sublimation system comprising:
a) a heating tunnel;
b) a conveyer belt; and
c) a loading tray having a vacuum element.

17. The system of claim 16, wherein the loading tray comprises a upper section having one or more sublimation jig and a lower section containing a vacuum device.

18. The system of claim 17, wherein the vacuum device comprises a pump.

19. The system of claim 17, wherein the heating tunnel comprises a power supply extending along the heating tunnel.

20. The system of claim 17, wherein loading tray having a vacuum device is powered by the power supply.
